(19) United States
(12) Patent Application Publication
(10) Pub. No.: US 2002/0190065 A1
(43) Pub. Date: Dec. 19, 2002

(54) Fuel feeding pipe for vehicle

(75) Inventors: Hiroshi Yoshida, Soja-shi (JP); Haruyoshi Iogawa, Soja-shi (JP); Hiroshi Goto, Soja-shi (JP)

Correspondence Address: Koda & Androlia, Suite 3850, 2029 Century Park East, Los Angeles, CA, 90067, US

(73) Assignee: OM CORPORATION

(21) Appl. No.: 10/170,280

(22) Filed: Jun. 12, 2002

(30) Foreign Application Priority Data
Jun. 13, 2001 (JP) 2001-178308

(51) Int. Cl. B67C 3/00

(52) U.S. Cl. 220/86.2

(57) ABSTRACT

In order to improve joint strength between a cap retainer and a conduit of a fuel feeding pipe for a vehicle having an alterable joint angle between the cap retainer and the conduit, the fuel feeding pipe for a vehicle is integrally formed by joining a cap retainer joint portion of the cap retainer and a conduit joint portion of the conduit, wherein the cap retainer joint portion has a band surface arc-shaped in cross section equivalent to a section of a sphere, the conduit joint portion has a band surface in cross section conforming in shape to the cap retainer joint portion, and the cap retainer joint portion is brought into surface contact with the conduit joint portion to join the two joint portions and join the cap retainer and the conduit.

### BACKGROUND OF THE INVENTION

1. Technical Field

The present invention particularly relates to a fuel feeding pipe for a vehicle constituting a path for filling fuel into a vehicle fuel tank.

2. Related Art

A general fuel feeding pipe for a vehicle is formed by joining a separate cap retainer and a conduit, but this causes the following problems. In a general fuel pipe for a vehicle, joint strength of a joint portion sharply bent in the vicinity of a cap retainer because of the layout is improved by a complicated joint shape.

There has been a call for lightweight vehicles and control of evaporated fuel generation due to environmental problems, and as a result, it is necessary to provide a conduit with a narrower diameter and reduced thickness. However, when the diameter of the cap retainer is regulated by law (in the States, etc.), if a conduit is narrowed, this conduit must be widened toward the cap retainer joining area. However, the narrower the diameter of the conduit becomes and the thinner the thickness becomes, the more difficult it is to widen the cap retainer joining area of the conduit. It is therefore impossible to widen the conduit to the required size in a single process. Consequently, conduits that are sequentially widened in many steps have become difficult to manufacture and expensive. In addition, as a result of a recent trend to produce a wide range of products in small volume, the number of parts is increased because joint angles of the joining cap retainers vary depending on vehicle types, even if conduits are identical. Therefore, a fuel feeding pipe for a vehicle having a pipe with a narrow diameter and with a reduced thickness, that can be joined with a regulation cap retainer, and that can be manufactured inexpensively with fewer manufacturing processes, has been sought.

In response to the needs for the above fuel feeding pipe for a vehicle, the inventors have proposed a fuel feeding pipe disclosed in JP9-066747A, with a structure where a joint side under a cap latching portion of a cap retainer with a conduit is substantially a sphere, and an end portion of the conduit having a smaller diameter than that of the cap retainer is tightly abutted to join with the cap retainer joint portion. This fuel feeding pipe for a vehicle can improve material yield by having a freely alterable joint angle for one type of cap retainer and conduit, and making respective manufacturing processes of the cap retainer and the conduit simpler. Above all, since a narrow pipe with reduced thickness can be used as a material for the conduit for contacting with the sphere of the cap retainer, a lightweight and significantly cheaper fuel feeding pipe for a vehicle can be obtained.

In the fuel feeding pipe for a vehicle disclosed in JP9-066747A, the joint angle of the cap retainer and the conduit can be freely altered without a special process, the same cap retainer and conduit components can be used regardless of vehicle type, and a conduit with a small diameter can be used. As a result, it is possible to achieve a lightweight fuel feeding pipe and suppression of fuel evaporation. However, improvement of joint strength is found to be difficult depending on the situation because a peripheral end of a conduit is abutted against a spherical cap retainer in a tangential manner and is joined by welding along the peripheral end of the conduit. Therefore, investigations have been carried out in order to develop a structure to improve the joint strength between a cap retainer and a conduit, based on the structure of the fuel feeding pipe for a vehicle in JP9-066747A.

### SUMMARY OF THE INVENTION

The present invention is a fuel feeding pipe for a vehicle integrally formed by joining a cap retainer joint portion of a cap retainer and a conduit joint portion of a conduit, wherein the cap retainer joint portion is a band surface arc-shaped in cross section equivalent to a section of a sphere, the conduit joint portion is a band surface conforming in shape to the cap retainer joint portion, and the cap retainer joint portion is brought into surface contact with the conduit joint portion to join the two joint portions and integrally join the cap retainer and the conduit. Since the cap retainer and the conduit can be joined in a substantially surface-contacted manner at the area of the conduit joint portion being a band surface arc-shaped in cross section, a joining operation becomes easy and brazing (a joining process using welding material such as molten metal) is possible to improve joint strength.

The shape of the sphere that is the base of the band surface arc-shaped in cross section of the cap retainer joint portion is not limited to being completely round, and two planes of the band surface, that are imaginary cross sections taken through a sphere need not necessarily be parallel.

Also, a fuel hose nozzle guide constituted by a reinforcement ring can be provided at the peripheral end of the band surface arc-shaped in cross section. This fuel hose nozzle guide functions to correctly guide a fuel hose nozzle into the conduit by contacting the outside of the fuel hose nozzle, and also to improve the structural strength of the cap retainer joint portion. The reinforcement ring can be a cylindrical ring constituted by the side surface of the band surface arc-shaped in cross section folded in the tangential direction, a flange projecting inward or outward diagonal to the axis of the cap retainer, or an entrainment ring formed by curling, etc.

Similarly, the conduit joint portion is a band surface arc-shaped in cross section (body of rotation of an arc) equivalent to a section of a sphere, or a band surface having a straight line cross sectional shape equivalent to a section of a truncated cone side surface (body of rotation of a straight line). In the conduit joint portion formed of individual band surfaces, the joint angle against the cap retainer joint portion can be sequentially altered.

When joining the cap retainer and the conduit by brazing, from the view point of easy pouring of brazing filler metal, the conduit joint portion can be contiguously provided with an open band surface opening out from the peripheral end of the conduit joint portion in the direction away from the cap retainer joint portion. This open band surface is not a section directly related to the joint strength of the cap retainer and the conduit. However, this will be (1) a positioning guide for placing the conduit joint portion with the cap retainer joint portion, and (2) a guide for pouring brazing filler metal to the interface between the cap retainer joint portion and the conduit joint portion at the time of brazing.

### BRIEF DESCRIPTION OF THE DRAWINGS

FIG. 1 is a cross-sectional view showing an example of the fuel feeding pipe for a vehicle of the present invention.

FIG. 2 is a cross-sectional view equivalent to the enlargement of the section shown by the arrow A of FIG. 1, showing a cap retainer joint portion and a conduit joint portion.

FIG. 3 is a cross-sectional view equivalent to the enlargement of the section shown by the arrow A of the FIG. 1, showing another example of a conduit joint portion.

FIG. 4 is a cross-sectional view equivalent to FIG. 1, showing the joint angle of the cap retainer facing upward with respect to the conduit.

FIG. 5 is a cross-sectional view equivalent to FIG. 1, showing the joint angle of the cap retainer facing downward with respect to the conduit.

FIG. 6 is a cross-sectional view equivalent to the enlargement of the section shown by arrow A of FIG. 1, showing the conduit joint portion contiguously provided with an open band surface made of a truncated cone side surface.

FIG. 7 is a cross-sectional view equivalent to the enlargement of the section shown by arrow A of FIG. 1, showing the conduit joint portion contiguously provided with an open band surface opening out from the peripheral end of the band surface of the conduit joint portion conforming in shape to the cap retainer joint portion in a direction away from the cap retainer joint portion.

### DETAILED DESCRIPTION OF THE INVENTION

Embodiments of the present invention will now be described in the following.

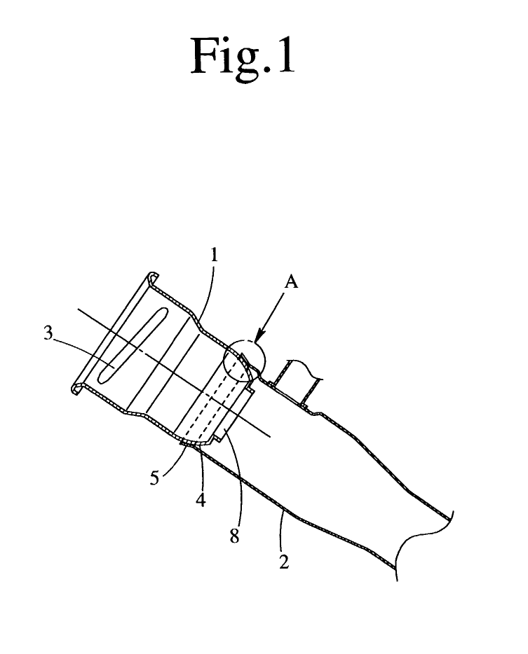

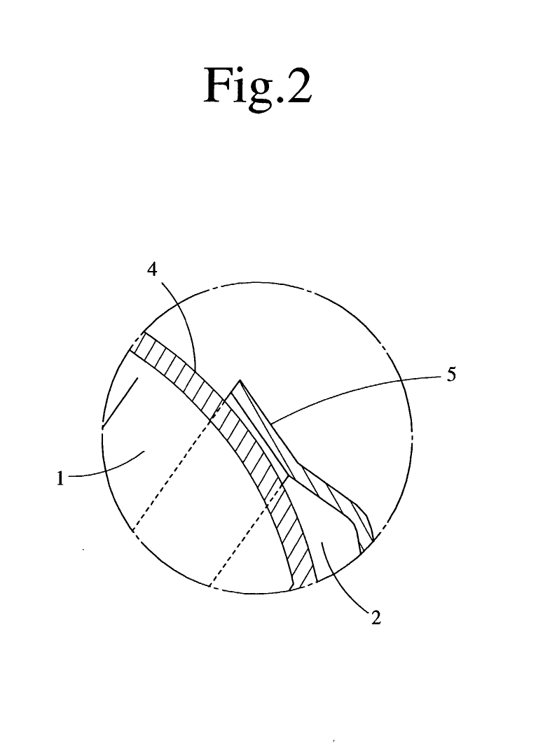

A fuel feeding pipe for a vehicle based on the present invention, as shown in FIG. 1, is constructed by joining a cap retainer 1 and a conduit 2. In the cap retainer 1, a cap retainer joint portion 4 is formed under a cap latching portion 3. The shape of the cap retainer joint portion 4 of this example, as shown in FIG. 2, is a band surface arc-shaped in cross section equivalent to a section of a sphere. The cap retainer joint portion 4 is tapered toward the conduit 2, and a fuel hose nozzle guide 8 that is an annular flange folded from the peripheral end of this tapered band surface arc-shaped in cross section is provided. In the conduit 2, a conduit joint portion 5 is formed by radially expanding a peripheral end of the conduit on the side joining with the cap retainer. The conduit joint portion 5 of this example, as shown in FIG. 2, is a band surface having a straight line cross sectional shape constituted by a side surface of a truncated cone with an inclination angle.

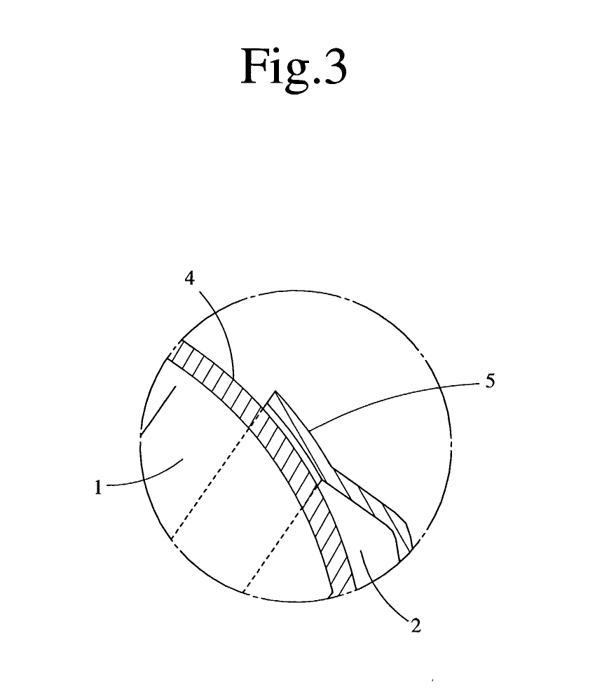

In FIG. 2, although a space is shown provided between the cap retainer joint portion 4 and the conduit joint portion 5 for the sake of convenience of description, more accurately it is provided in a line contacting manner, and in actual fact it is close to being in a surface-contacted state. In order to achieve close surface contact, as shown in FIG. 3, the conduit joint portion 5 can be formed into a band surface arc-shaped in cross section, the shape conforming to the cap retainer joint portion 4. The cap retainer 1 and the conduit 2 are integrally formed by joining the cap retainer joint portion 4 and the conduit joint portion 5 using the conduit joint portion having a broad area as a welding area, by laser beam welding, arc welding, or brazing.

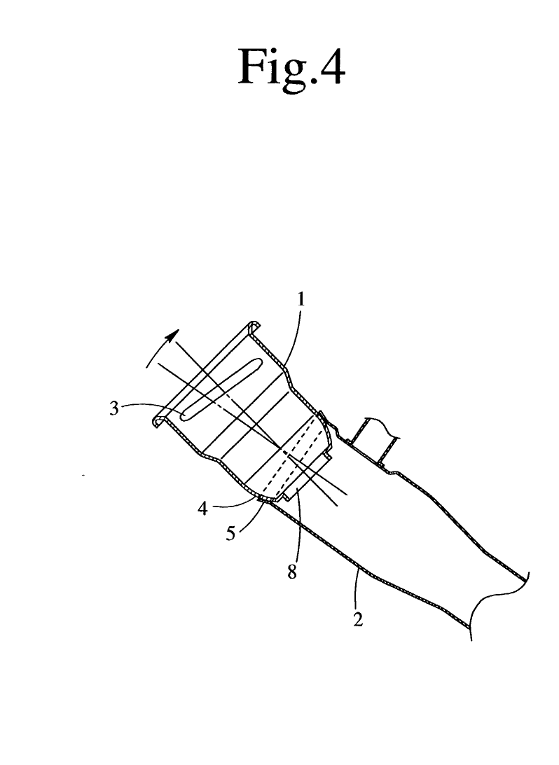

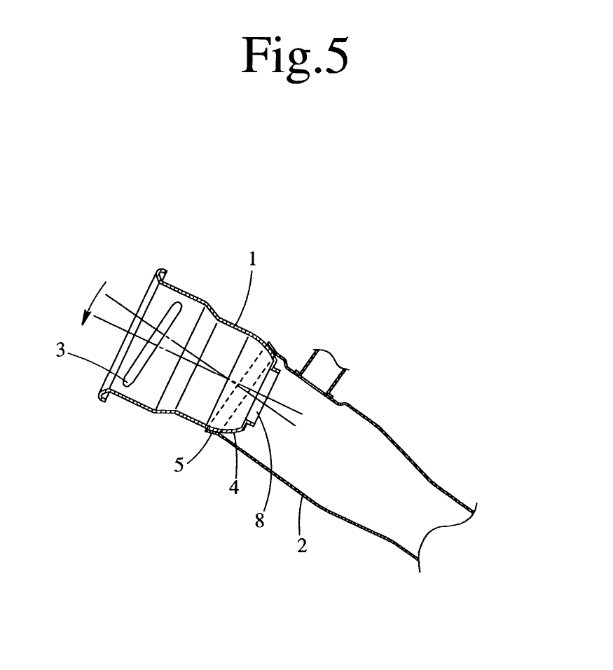

Since the cap retainer joint portion 4 is a band surface arc-shaped in cross section, the state of contact between the cap retainer joint portion 4 and the conduit joint portion 5 is the same regardless of the joint angle, as long as it is within the range of the cap retainer joint portion 4, and therefore an easy joining process and joint strength will be maintained. As a result, as shown in FIG. 4 or FIG. 5, the joint angle of the cap retainer 1 in relation to the conduit 2 can be altered in an upward or downward direction. Obviously, since the cap retainer joint portion 4 is a band surface arc-shaped in cross section equivalent to a section of a sphere divided by an end surface (plane surface) that does not pass through a radial center, the joint angle can also be altered to the right or left, namely in any direction through 360 degrees. As is obvious from the drawings, pulling or inserting the fuel hose nozzle can be easily managed because the fuel hose nozzle guide 8 is provided toward the conduit 2.

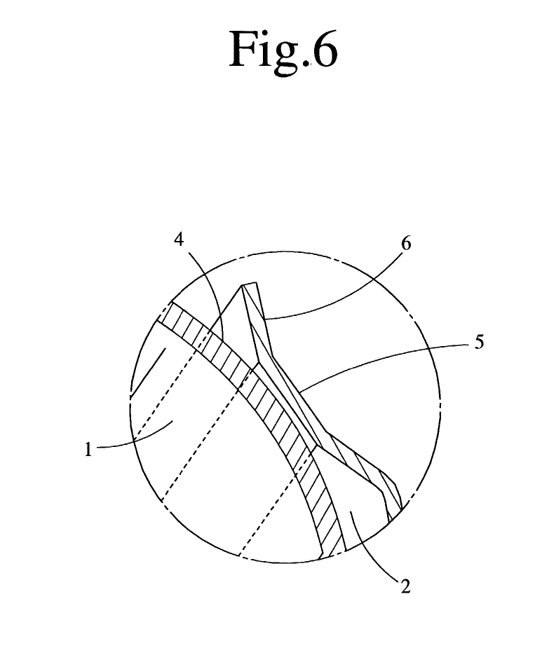

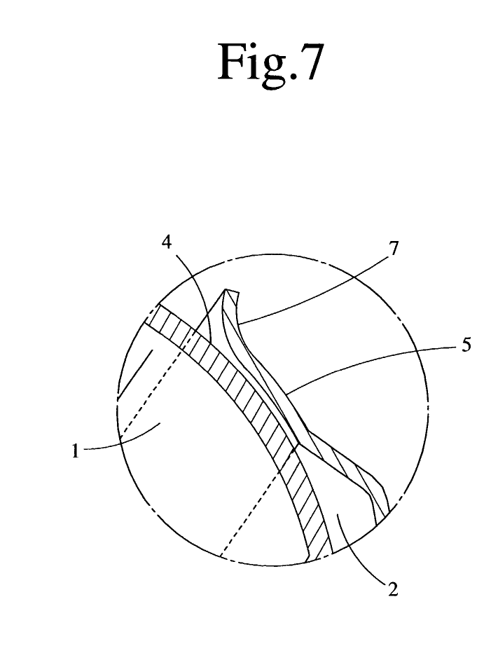

When brazing is employed as a joining method, brazing filler metal must be poured between the cap retainer joint portion 4 and the conduit joint portion 5 being in a surface-contacted state. An open band surface 6 in FIG. 6 constituted by a side surface of a truncated cone with an inclination angle, or an open band surface 7 in FIG. 7 equivalent to a section of a sphere divided by a cross-section that does not pass through a radial center will be a guide for pouring the brazing filler metal, and will make a joining operation easy. Also, either the open band surface 6 or the open band surface 7 can also be used as a positioning guide for placing the conduit joint portion 5 against the cap retainer joint portion 4 before the joining operation, and as a result, the assembly operation is made easy.

According to the fuel feeding pipe for a vehicle of the present invention, the joint strength of the cap retainer and the conduit, having a freely alterable joint angle, can be improved. In addition, as well as laser beam welding and arc welding, brazing requiring a surface-contacted state can be employed as a joining method, achieving diversification with respect to the joining operation, and improving flexibility of production lines. Also, the open band surface contiguously provided with the conduit joint portion works as a positioning guide for assembly and a guide for pouring brazing filler metal at the time of brazing, resulting in an easy operation.

In this manner, joining strength of a fuel feeding pipe for a vehicle having a freely alterable joint angle of a cap retainer and a conduit can be improved, and a more durable fuel feeding pipe for a vehicle can be provided. The alterable joint angle is effective for preventing increase in the number of components due to different car types, and the present invention has the effect of providing a fuel feeding pipe for a vehicle having a stable structural strength for a greater variety of car types despite using the same cap retainer and conduit by further improving joint strength of the cap retainer and the conduit.

What is claimed is:

1. A fuel feeding pipe for a vehicle integrally formed by joining a cap retainer joint portion of a cap retainer and a conduit joint portion of a conduit, wherein the cap retainer joint portion has an arc-shaped band surface in cross section equivalent to a section of a substantially hollow sphere, the conduit joint portion has a cross sectional band surface conforming in shape to the cap retainer joint portion, and the cap retainer joint portion is brought into surface contact with the conduit joint portion to join the two joint portions and integrally join the cap retainer and the conduit.

2. The fuel feeding pipe for a vehicle according to claim 1, wherein the cap retainer joint portion is contiguously provided with a fuel hose nozzle guide constituted by a reinforcement ring at the peripheral end of the arc-shaped band surface in cross section.

3. The fuel feeding pipe for a vehicle according to claim 1, wherein the band surface of the conduit joint portion conforming in shape to the cap retainer joint portion is a band surface having an arc-shaped cross section equivalent to a section of a cross section of a substantially hollow sphere.

4. The fuel feeding pipe for a vehicle according to claim 1, wherein the band surface of the conduit joint portion conforming in shape to the cap retainer joint portion is made a band surface having a straight line cross sectional shape equivalent to a section of a truncated cone side surface.

5. The fuel feeding pipe for a vehicle according to claim 1, wherein the conduit joint portion is contiguously provided with an open band surface opening out from the peripheral end of the band surface of the conduit joint portion conforming in shape to the cap retainer joint portion in a direction away from the cap retainer joint portion.

6. The open band surface according to claim 5, wherein a shape thereof constituted by a side surface of a truncated cone with an inclination angle.

7. The open band surface according to claim 5, wherein a shape thereof equivalent to a section of a sphere divided by a cross-section hat does not pass through a radial center.
